(19) United States
(12) Patent Application Publication
(10) Pub. No.: US 2018/0330582 A1
(43) Pub. Date: Nov. 15, 2018

(54) BLUETOOTH SERVICE CALL SYSTEM

(71) Applicant: Linctronix Ltd., New Taipei City (TW)

(72) Inventor: Yu-Shun Lin, New Taipei (TW)

(21) Appl. No.: 15/970,687

(22) Filed: May 3, 2018

(30) Foreign Application Priority Data
May 9, 2017 (TW) 106115324

(51) Int. Cl. G08B 5/22; H04W 68/00; H04W 4/06

(52) U.S. Cl. CPC G08B 5/224; H04W 76/14; H04W 4/06; H04W 68/005

(57) ABSTRACT

A Bluetooth service call system for a customer calling a waiter to provide service content in the business area includes a Bluetooth pager. The Bluetooth pager further includes at least one trigger button for the customer to operate a trigger button to send a service request message; a wireless base station for receiving a service request message and sending a service message; a wireless receiving device, worn by the waiter for receiving the service message; and a cloud console for setting the trigger button corresponding to the service content and saving the Bluetooth pager's location table and the service table. Under such conditions, the Bluetooth service call system can change the service content of the trigger button by simple setting and be widely utilized in various applications that require different service.

### CROSS-REFERENCE TO RELATED APPLICATIONS

This application claims the priority benefit of Taiwan Application Serial No. 106115324 filed May 9, 2017 the disclosure of which is incorporated herein by reference.

### BACKGROUND OF THE INVENTION

### 1. Field of the Invention

The present invention relates to a Bluetooth service call system, and more particularly, to a Bluetooth service call system for a user to change the service content of the trigger button by simple setting. A user, such as a customer, may press the trigger button through the Bluetooth communication protocol for sending service messages to the wireless receiving device worn by service personnel; therefore, the purpose of customer service is achieved.

### 2. Description of the Prior Art

With the progress of science and technology, human's food culture has been gradually changing. For example, the traditional barbecue restaurants uses artificial barbecue. In comparison, modern barbecue restaurants are using mechanical barbecue, which not only has the advantages of time precision but also confirms the quality for standardization. With the changes in the food culture, the restaurant's service content has been technological. The ordering service in the restaurants has evolved from the traditional way that waiters writie with pens and papers into the way that the waiters carry the mobile device for ordering. This approach not only increases the efficiency of ordering but also achieves the paperless advantage for being environmental friendly.

Today, there is still a problem on how to call a service staff. The current practice of calling the service staff is by way of ringing a service bell or waving hands directly. However, it is not easy for the service staff to notice the customer's call in a crowded or noisy restaurant environment. Furthermore, it is rude to casually wave in a quiet dining environment. On the other hand, the service staff has to walk repeatedly between the kitchen and the customers in order to convey the service content, which will result in the waste of human resource.

In recent years, some restaurants use an automatic ordering system. In one case, the customers use the smart tablet on the dining table for ordering. After finishing the order, the customers can pick up their own meals at the restaurant counter. This process is beneficial for saving the human resources, but the customers will lose the chance of face-to-face contact with waiters, for which the high-quality customer service in today's customer-oriented catering business is quite valued.

### SUMMARY OF THE INVENTION

Therefore, the present inventor with many years engaged in the manufacture and development of related products and design experience went through the detailed design and careful assessment to finally confirm that the present invention is practically usable.

A primary object of the present invention is to provide a Bluetooth service call system for a customer calling a waiter to provide a service content in the business area. The present invention Bluetooth service call system comprises: a Bluetooth pager configured in the business area, wherein the Bluetooth pager further comprises at least one trigger button and a Bluetooth wireless transmission module connected to the trigger button, and the trigger button is configured for the customer to control the Bluetooth wireless transmission module to send a service request message; a wireless base station wirelessly connected to the Bluetooth pager for receiving a service request message and sending a service message; a wireless receiving device wirelessly connected to the wireless base station for receiving the service message, wherein the wireless receiving device is worn by the waiter and the waiter can provide the service content according to the service message; and a cloud console wirelessly connected to the wireless base station for setting the trigger button corresponding to a service table, and saving the service table and a location table of the Bluetooth pager, wherein the service table and the location table are transferred to the wireless base station.

According to one embodiment of the present invention, the wireless base station further comprises a base station Bluetooth module and a base station network module, and the wireless base station sequentially receives the service request message by the base station Bluetooth module and sends the service message by the base station network module.

Furthermore, the wireless base station receives the location table of the Bluetooth pager and the service table of the trigger button from the cloud console, and the wireless base station further stores the location table and the service table. Thus, the present invention Bluetooth service call system can operate when the cloud console is disconnected from the Bluetooth service call system.

In an embodiment, the service request message comprises a device identification code of the Bluetooth pager and at least one button information corresponding to the trigger button. The wireless base station generates a location information according to the device identification code and the location table, and the wireless base station further generates a service information according to the button information and the service table. The wireless base station sends the service message, wherein the service message comprises the location information and the service information.

According to another embodiment of the present invention, the trigger button is at least one entity button or one touch button. The wireless receiving device is a smart bracelet and the smart bracelet further comprises a display screen. The smart bracelet will generate a flash signal, a vibration signal or a sound signal to inform the waiter to provide service content when the smart bracelet receives a service message. Further, the service message is shown on the display screen.

In comparison with the conventional technology, the present invention Bluetooth service call system uses the Bluetooth pager to send the service request message so that the waiter can immediately catch the needs and the position of the customers who send the service request message. Thus, the service efficiency can be improved. Furthermore, the present invention can be widely applied to various applications through setting and changing the definition of the trigger button by the user.

The advantages and spirits of the invention may be understood by the following recitations together with the appended drawings.

### BRIEF DESCRIPTION OF THE APPENDED DRAWINGS

Some of the embodiments will be described in detail, with reference to the following figures, wherein like designations denote like members, wherein:

FIG. 1 shows a functional block diagram of the Bluetooth service call system in one embodiment of the present invention.

FIG. 2 shows a system structure diagram of the Bluetooth service call system in one embodiment of the present invention.

FIG. 3 shows a schematic diagram of the Bluetooth service call system in one embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

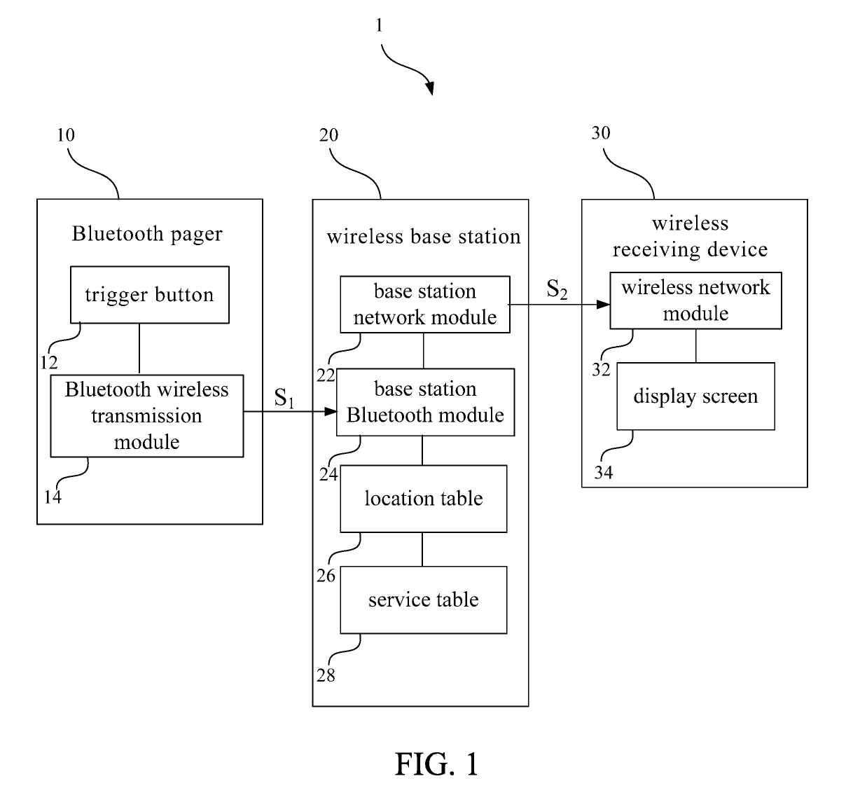

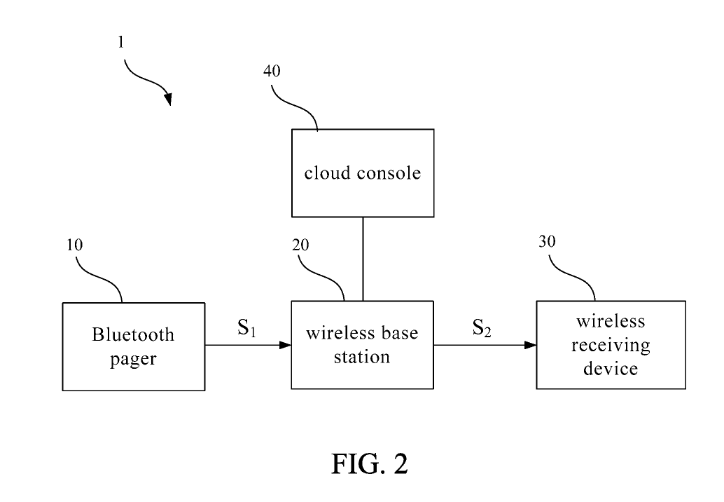

Please refer to FIG. 1 and FIG. 2. FIG. 1 shows a functional block diagram of the Bluetooth service call system 1 in one embodiment of the present invention. FIG. 2 shows a system structure diagram of the Bluetooth service call system 1 in one embodiment of the present invention. In one embodiment, the present invention provides a Bluetooth service call system 1 for a customer calling a waiter to provide a service content in the business area. The Bluetooth service call system 1 comprises a Bluetooth pager 10, a wireless base station 20, a wireless receiving device 30 and a cloud console 40.

According to the embodiment above mentioned, the Bluetooth pager 10 of the present invention is configured in the business area that is easily accessible for the customers. For example, the Bluetooth pager 10 is configured under a dining table, at the edge of the dining table or on the cinema chair. The Bluetooth pager 10 further comprises at least one trigger button 12 and a Bluetooth wireless transmission module 14 connected to the trigger button 12. Besides, the trigger button 12 is at least one entity button or one touch button (e.g., a touch button for the tablet computer). When the trigger button 12 is pressed, the Bluetooth wireless transmission module can detect the pressed trigger button 12 through the general-purpose output input (GPIO) interface, the 12C interface or the SPI interface, and send a service request message S1. Wherein the service request message S1 comprises one of the device identification codes of the Bluetooth pager 10 and one of the button information corresponding to at least one of the trigger buttons 12.

According to the embodiment above mentioned, the wireless base station 20 of the present invention further comprises a base station Bluetooth module 24, a base station network module 22, a location table 26, and a service table 28. The wireless base station 20 is wirelessly connected to the Bluetooth pager 10 and utilizes the base station Bluetooth module 24 to communicate with the Bluetooth wireless transmission module 14 for receiving the service request message S1. The wireless base station 20 generates a location information according to the device identification code and the location table 26, and the wireless base station further generates a service information according to the button information and the service table 28. The base station network module 22 sends the service message S2, wherein the service message S2 comprises the location information and the service information.

According to the embodiment above mentioned, the wireless receiving device 30 of the present invention is worn by the waiter 200, and the wireless receiving device 30 further comprises a wireless network module 32 and a display screen 34. The wireless receiving device 30 is wirelessly connected to the wireless base station 20, and the wireless network module 32 communicates with the base station network module 22 to receive the service message S2. The display screen 34 is configured to display location information and service information contained in the service message S2, and the waiter 200 provides corresponding service contents according to the location information and service information.

According to the embodiment above mentioned, the cloud console 40 of the present invention is wirelessly connected to the wireless base station 20. The cloud console 40 stores the location table 26 of the Bluetooth pager 10 and the service table 28 of the trigger button 12, and the cloud console 40 has the authority of setting the location table 26 and the service table 28. That is, the service content represented by each of the trigger buttons 12 can be modified at any time through the cloud console 40, and the location corresponding to the device identification code of each Bluetooth pager 10 can be modified. Furthermore, the cloud console 40 disconnects the wireless base station 20 after the service table 28 and the location table 26 are transferred to the wireless base station and are stored in the wireless base station 20. The customer can use the Bluetooth pager 10 to call the waiter without the connection between the wireless base station 20 and the cloud console 40.

the location table 26 and the service table 28 after setting are transmitted to the wireless base station 20 for storing, and the wireless base station 20 can be disconnected from the cloud console 40, so that the customer can use the Bluetooth pager 10 to call the waiter without the connection between the wireless base station 20 and the cloud console 40.

According to the embodiment above mentioned, the base station network module 22 can be one of Bluetooth modules, Wi-Fi modules, IEEE802.11 specifications, Zigbee specifications, and other wireless network modules. The wireless network module 32 is the network module that can communicate with the base station network module 22. The base station Bluetooth module 24 and the base station network module 22 may be the same network module or different network modules. For example, the Bluetooth pager 10 transmits the service request message S1 to the wireless base station 20 through Bluetooth, and the wireless base station 20 further transmits the service message S2 to the wireless receiving device 30 through Wi-Fi. For another example, the Bluetooth pager 10 transmits the service request message S1 to the wireless base station 20 through Bluetooth, and the wireless base station 20 transmits the service message S2 to the wireless receiving device 30 through Bluetooth as well.

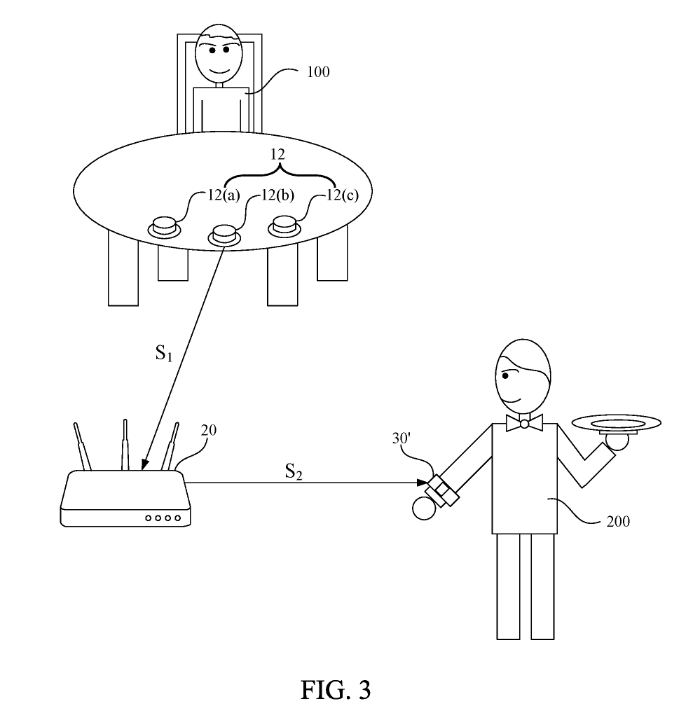

Please refer to FIG. 3. FIG. 3 shows a schematic diagram of the Bluetooth service call system 1 in one embodiment of the present invention. In one embodiment, the business area is a restaurant, and the wireless receiving device 30 is a smart hand ring 30′. When the customer 100 presses the trigger button 12, the Bluetooth pager 10 sends a service request message S1 to the wireless base station 20. After receiving the service request message S1, the wireless base station 20 obtains the location of the Bluetooth pager 10 according to the location table 26 and the service table 28 corresponding to the service request message S1. The wireless base station then selectively sends the service message S2 to at least one smart hand ring 30′ worn by a service personnel (e.g., waiter 200). Furthermore, the wireless base station 20 may selectively send the service message S2 to one or more service personnel (e.g., waiter 200) responsible for the business area where the customer 100 is located. For another embodiment, the wireless base station 20 may send the service message S2 to the dedicated service personnel according to the service content. For the other embodiment, the wireless base station 20 sends the service message S2 to a service personnel (e.g., waiter 200) closest to the Bluetooth pager 10 by calculating the wireless signal strength (RSSI). When the smart hand ring 30′ receives the service message S2 sent by the wireless base station 20, a flashing signal, a vibration signal or an audio signal is generated to remind the waiter 200 to read the service message S2. The service message S2 is shown on the display screen 34, wherein the service message S2 comprises the location information and the service information. In practice, the smart hand ring 30′ includes idle and busy functions that can be selected by the service personnel (e.g., waiter 200) or automatically switched by the smart hand ring 30′. For example, when the smart hand ring 30′ worn by the waiter 200 receives the service message S2 as a meal service, the smart hand ring 30′ will automatically switch to the busy mode within the next five minutes, thus during this period, the smart hand ring 30′ will not receive other service message S2.

In practice, the button information of the service request message S1 is selected from the group consisting of a fixed code, a message code, a text, a graphic, and combinations thereof. The service information of the service message S2 is selected from the group consisting of a fixed code, a message code, a text, a graphic, and combinations thereof. The location information of the service message S2 is selected from the group consisting of a table number, a seat number, a region code, and combinations thereof.

Please refer to FIG. 3. In one embodiment, the button information is a fixed code, the service information is a text, and the location information is a table number. In this embodiment, the trigger buttons 12(a), 12(b), and 12(c) of FIG. 3 respectively represent a meal ordering service, a water filling service and a checkout service. When the customer 100 presses the trigger button 12(a), the Bluetooth pager 10 sends a service request message S1, wherein the service request message S1 comprises the device identification code “001” of the Bluetooth pager 10 and a button information “button a” of the trigger button 12(a), wherein the button information “button a” is a fixed code. After receiving the service request message S1, the wireless base station 20 obtains the service content of “button a” according to the service table as “meal ordering service”, and the device identification code “001” corresponds to the table number of the location table as “table number 1”. Therefore, the wireless base station 20 sends the service message S2 comprising the location information “table number 1” and the service information “meal ordering service” to the smart hand ring 30′, wherein the service message S2 is shown on the display screen 34.

In practice, the button information of the trigger buttons 12 can be changed through cloud console 40. Please refer to FIG. 3. In another embodiment, the button information is a text, the service information is a picture, and the location information is a region code. In this embodiment, the trigger buttons 12(a), 12(b), and 12(c) of FIG. 3 respectively represent a meal ordering service, a water filling service and a checkout service. When the customer 100 presses the trigger button 12(c), the Bluetooth pager 10 sends a service request message S1, wherein the service request message S1 comprises the device identification code “001” of the Bluetooth pager 10 and a button information “button c” of the trigger button 12(c), wherein the button information is a fixed code showing “checkout service”. After receiving the service request message S1, the wireless base station 20 obtains the service content of “checkout service” according to the service table as the picture “checkout counter”, and the device identification code “001” corresponds to the region code of the location table as “region A”. Therefore, the wireless base station 20 sends the service message S2 comprising the location information “region A” and the service information of the picture “checkout counter” to the smart hand ring 30′, wherein the service message S2 is shown on the display screen 34.

In one embodiment, the cloud console 40 can store the location table 26 and the service table 28 at the wireless receiving device 30 through wireless base station 20. When the wireless base station 20 receives the service request message S1, the wireless base station 20 directly transforms the service request message S1 into the service message S2 (without going through the location table 26 and the service table 28) and sends the service message S2 to the wireless receiving device 30. Therefore, the wireless receiving device 30 receives the customer location and service content according to the location table 26 and the service table 28 of the service information S2. Please refer to FIG. 2. For example, when the customer 100 presses the trigger button 12(b) to transmit the service request message S1 comprising the device identification code “001” and the button information “Water”, the wireless base station 20 receives the service request message S1 and transmits the service request message S1 directly to the smart hand ring 30′. The smart hand ring 30′ obtains the service content of the button information “Water” representing “add water” according to the service table, and the device identification code “001” represents “table number 1” according to the location table. Therefore, the service message S2 of “Table 1 customers need to add water” is shown on the display screen 34.

The Bluetooth in the above specific embodiment is any version of the Bluetooth communication protocol defined by the Bluetooth association, for example, as defined in the Bluetooth 2.0 protocol series, the Bluetooth 3.0 protocol series, the Bluetooth 4.0 protocol series or the Bluetooth 5.0 protocol series Bluetooth devices.

The wireless local area network of the above specific embodiment is any version of the 802.11 protocol defined by WiFi or IEEE, for example, including 802.11, IEEE 802.11a, 802.11b, 802.11g, 802.11h, 802.11n, 802.11p, 802.11ac, 802.11ah, 802.11aq, 802.11ax and the like.

In comparison with the prior art, the present invention Bluetooth service call system uses the Bluetooth pager to send the service request message so that the waiter can immediately catch the needs and the position of the customers who send the service request message. Therefore, the present invention solves the inconvenience of waving calls for the service personnel in the traditional restaurant. In comparison with the automatic ordering system, the present invention retains the advantages of the entity service provided by service personnel. Whether in service quality or the customer experience, the present invention is superior to the traditional ordering and automatic ordering. Another feature of the present invention Bluetooth service call system is that the user can change the definition of the trigger button by simple settings. This means that the same system can be widely utilized in various applications that require different services; for example, hospitals, cinemas, and restaurants. Meanwhile, the problem that the entire system needs to be rewritten by the engineer due to the change of using situation is avoided.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A Bluetooth service call system for a customer calling a waiter to provide a service content in a business area, comprising:
a Bluetooth pager configured in the business area, wherein the Bluetooth pager further comprises at least one trigger button and a Bluetooth wireless transmission module connected to the trigger button, and the trigger button is configured for the customer to control the Bluetooth wireless transmission module to send a service request message;
a wireless base station wirelessly connected to the Bluetooth pager for receiving a service request message and sending a service message;
a wireless receiving device wirelessly connected to the wireless base station for receiving the service message, wherein the wireless receiving device is worn by the waiter, and the waiter can provide the service content according to the service message; and
a cloud console wirelessly connected to the wireless base station for setting the trigger button corresponding to a service table, and saving the service table and a location table of the Bluetooth pager, wherein the service table and the location table are transferred to the wireless base station.

2. The Bluetooth service call system of claim 1, wherein the wireless base station further comprises a base station Bluetooth module and a base station network module, and the wireless base station sequentially receives the service request message by the base station Bluetooth module and sends the service message by the base station network module.

3. The Bluetooth service call system of claim 1, wherein the wireless base station receives the location table of the Bluetooth pager and the service table of the trigger button from the cloud console, and the wireless base station further stores the location table and the service table.

4. The Bluetooth service call system of claim 1, wherein the service request message comprises a device identification code of the Bluetooth pager and at least one button information corresponding to the trigger button.

5. The Bluetooth service call system of claim 4, wherein the button information is selected from the group consisting of a fixed code, a message code, a text, a graphic, and combinations thereof

6. The Bluetooth service call system of claim 4, wherein the wireless base station generates a location information according to the device identification code and the location table, and the wireless base station further generates a service information according to the button information and the service table.

7. The Bluetooth service call system of claim 6, wherein the service message comprises the location information and the service information.

8. The Bluetooth service call system of claim 6, wherein the location information is selected from the group consisting of a table number, a seat number, a region code, and combinations thereof

9. The Bluetooth service call system of claim 6, wherein the service information is selected from the group consisting of a fixed code, a message code, a text, a graphic, and combinations thereof

10. The Bluetooth service call system of claim 6, wherein the service table and the location table are stored in the wireless receiving device for the waiter to provide the service content according to the service table and the location table when the wireless receiving device receives the service message.

11. The Bluetooth service call system of claim 1, wherein the wireless receiving device is a smart hand ring and the smart hand ring further comprises a display screen for displaying the service message.

12. The Bluetooth service call system of claim 1, wherein the wireless receiving device generates at least one of a flash signal, a vibration signal or a sound signal when the wireless receiving device receives the service message.

13. The Bluetooth service call system of claim 1, wherein the wireless base station receives a location information according to the device identification code and the location table, and the wireless base station further sends the service message to a selected wireless receiving device of the waiter.

14. The Bluetooth service call system of claim 1, wherein the trigger button is at least one of the entity buttons or touch buttons.

15. The Bluetooth service call system of claim 1, wherein the cloud console disconnects the wireless base station after the service table and the location table are transferred to the wireless base station, so that the customer can use the Bluetooth pager to call the waiter without the connection between the wireless base station and the cloud console.
